(19) United States
(12) Patent Application Publication
(10) Pub. No.: US 2012/0273650 A1
(43) Pub. Date: Nov. 1, 2012

(54) SYSTEM FOR REGULATING THE BRIGHTNESS IN AN AEROPLANE

(75) Inventors: Dirk-Achim SCHEVARDO, Roethenbach (DE); Martin BACHHUBER, Altdorf (DE); Ralph PÄTZOLD, Roth (DE)

(73) Assignee: DIEHL AEROSPACE GMBH, Ueberlingen (DE)

(21) Appl. No.: 13/448,772

(22) Filed: Apr. 17, 2012

(30) Foreign Application Priority Data
Apr. 27, 2011 (DE) 10 2011 018 672.7

(51) Int. Cl. G01J 1/26; G01J 1/20

(52) U.S. Cl. 250/201.1

(57) ABSTRACT

The invention relates to a system for regulating an adjustable brightness level in a cabin of an aeroplane, having a control device, which is designed to regulate a preset brightness value and has at least the following components:

an input unit for inputting a predetermined brightness value,

at least one sensor detecting the brightness,

an adjusting device for influencing at least one light source on the basis of a brightness value determined by the sensor.

### FIELD OF THE INVENTION

The invention relates to a system for adjusting the brightness in a cabin of an aeroplane.

### BACKGROUND OF THE INVENTION

At present, the brightness in an aeroplane is adjusted manually. In this case, a first option is for curtains or blinds provided at the windows to be drawn in order to keep out incoming external light. A second option is for lighting provided in the cabin to be switched on manually.

### SUMMARY OF THE INVENTION

An object on which the invention is based consists in maintaining a suitable brightness level in a cabin of aeroplanes without any manual intervention.

This object is achieved by the features of Patent claim 1. Further advantageous configurations of the invention are in each case subject matter of the dependent claims. These configurations can be combined with one another in a technologically sensible manner. The description, in particular in connection with the drawing, characterizes and specifies the invention in more detail.

The invention provides a system for regulating an adjustable brightness level in a cabin of an aeroplane, having a control device, which is designed to regulate a preset brightness value and has at least the following components:
an input unit for inputting a predetermined brightness value,
at least one sensor detecting the brightness,
an adjusting device for influencing at least one light source on the basis of a brightness value determined by the sensor.

The input unit can have a user interface on which the adjusted brightness value is represented and can be adjusted. The control device receives a signal corresponding to the actual brightness value from at least one sensor and regulates at least one light source via the adjusting device. There is therefore no need for any manual intervention when making changes to the brightness. A brightness which has been adjusted once can be regulated automatically.

Corresponding to an advantageous embodiment, the light source is external light entering from outside through the window, wherein the windows have a blackout unit, and these blackout units are driven by the adjusting device for influencing the light source. As soon as an increase in the brightness value measured at the sensor is detected, the blackout unit can be driven by the adjusting device and can counteract the brightness.

In accordance with a further advantageous embodiment, the blackout unit is a layer applied to the window which changes its transmission when an electrical voltage is applied. The windows thus remain transparent such that passengers are not dazzled but can continue to look through the window. Preferably, the transmission can be altered continuously or with comparatively short increments by virtue of a variable electrical voltage being output by the adjusting device. This makes it possible to respond in a targeted manner to an increased incidence of light from outside.

In a further advantageous configuration, the blackout unit can be formed from non-transmissive or slightly transmissive materials which can be drawn over the windows electromechanically, so as to at least partially cover said windows. For example, a blind, a curtain or the like can be provided. As a result, conventional aeroplanes can be equipped with the apparatus according to the invention with comparatively little complexity involved.

In accordance with a further advantageous configuration, the adjusting device for influencing the light source acts on lighting provided in the cabin, wherein the control device performs the regulation depending on the predetermined brightness value and the measured brightness value. In the case of an excessively low brightness of the light entering from outside, the lighting can supplement the natural light from outside.

In accordance with an advantageous configuration, the system is used to regulate both the external light entering the cabin via the blackout device and the cabin lighting. The brightness can be reduced by means of the blackout unit and increased by means of the lighting, preferably continuously or with small increments.

By virtue of the described measures, it is possible to provide a system for regulating the brightness with which energy for supplying the cabin lighting can be saved. This is achieved by virtue of artificial light of the cabin lighting being additionally introduced only in the event of a low level of light entering from outside, and this is preferably performed only to the required extent.

In accordance with a further advantageous configuration, the first adjusting device for regulating the blackout unit and the second adjusting device for regulating the lighting are decoupled from one another such that they perform the regulation independently of one another. In this case, the adjusting device for regulating the blackout unit can be regulated such that light entering from outside does not dazzle and trouble the passengers, but the windows still remain transparent.

Corresponding to an advantageous design of the system, the first adjusting device and the second adjusting device can be controlled via a common master unit. As a result, the cabin crew is provided with a particularly simple way of regulating the system. The master unit can be matched to each aeroplane individually.

In accordance with a further advantageous embodiment of the system, the first adjusting device for influencing the blackout unit is designed with priority over the second adjusting device for influencing the lighting.

This makes it possible to avoid a situation in which the first adjusting device blacks out the windows completely and the second adjusting device increases the lighting level of the cabin lighting to a greater extent than is necessary for adjusting a desired brightness.

Corresponding to an advantageous design of the system, the regulation has measures for damping the controller, for example an I component, in order to damp rapid or fluctuating changes in the brightness value. This makes it possible to avoid a situation in which the system is continually readjusted in the event of rapidly changing light conditions. The blackout unit is driven only after a certain duration of exposure to the incident light. The controlled system itself can have damping or respond so slowly that damping of the controller is not necessary.

In accordance with a further advantageous configuration, a brightness value can be predetermined manually beyond the brightness value detected by the sensor via the input unit. This can take place individually at a passenger seat, regionally or globally for the entire cabin. As a result, the blackout level or the brightness of the cabin lighting can be influenced, for example in the case of light entering from outside which is diffuse or is perceived to be disagreeable.

Corresponding to an advantageous embodiment, a sensor detecting the brightness is arranged at at least one window, with the result that the sensor determines the brightness of external light entering. In this case, the sensor can be positioned outside a range influenced by a blackout unit.

The invention proposes integrating the system in the cabin of an aeroplane, in particular a passenger aeroplane. The aeroplane can have a plurality of sections arranged one behind the other which are each equipped with a system of the described type. For example, different brightnesses in the cabins of the different service classes can be adjusted. The subdivision into regions can be selected so as to have small increments such that each window can be driven individually.

In accordance with an advantageous configuration, in this case the aeroplane has an aeroplane management system which is superordinate to the system and which is designed to overwrite any adjustments of the system or deactivate functions. As a result, the flight crew can deactivate the regulation of the brightness which is designed for increased comfort and introduce certain flight phases at any time.

In a particular embodiment, the system is configured such that dynamically changing light adjustments are predetermined, for example for identifying the emergency exits and safety devices during the explanation of the safety precautions.

### BRIEF DESCRIPTION OF THE DRAWINGS

An exemplary embodiment will be explained in more detail below with reference to the drawings, in which:

FIG. 1 shows a schematic side view of a section of an aeroplane,

FIG. 2 shows a side part of an aeroplane with a window which has a blackout unit, and

FIG. 3 shows a sectional illustration in the longitudinal direction of the aeroplane through part of the aeroplane skin, a window and a side part.

### DETAILED DESCRIPTION OF EXEMPLARY EMBODIMENTS

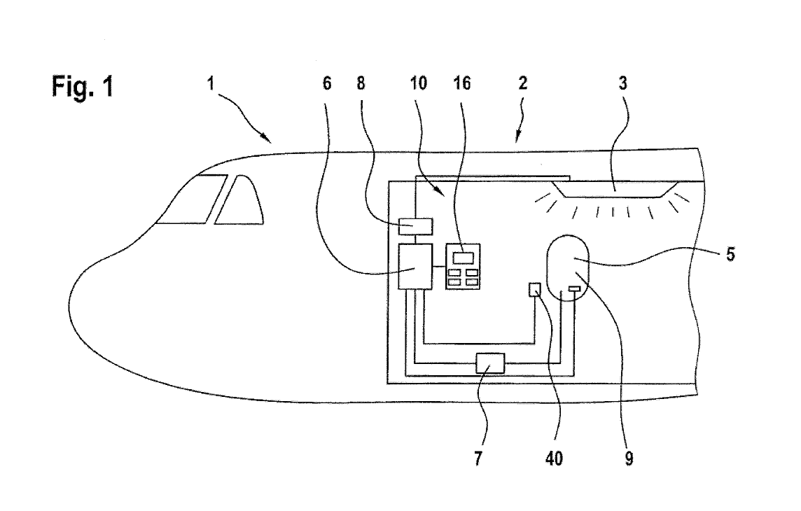

FIG. 1 shows a schematic illustration of a section of an aeroplane 1. The aeroplane 1 can be subdivided into a plurality of regions 2, of which only a first front region 2 is illustrated partially. The regions 2 can be equipped with a system for regulating the brightness. The regions 2 have cabin lighting 3, which can be driven and regulated by the system. A brightness value prevailing in the regions 2 is detected via at least one sensor 4. A desired brightness value can be adjusted using an adjusting device 16, said brightness value then being automatically maintained. Each side of the aeroplane can have at least one sensor 4 on the section for this purpose, said sensor detecting light entering the windows 5 and passing on a signal corresponding to the brightness to a control device 6.

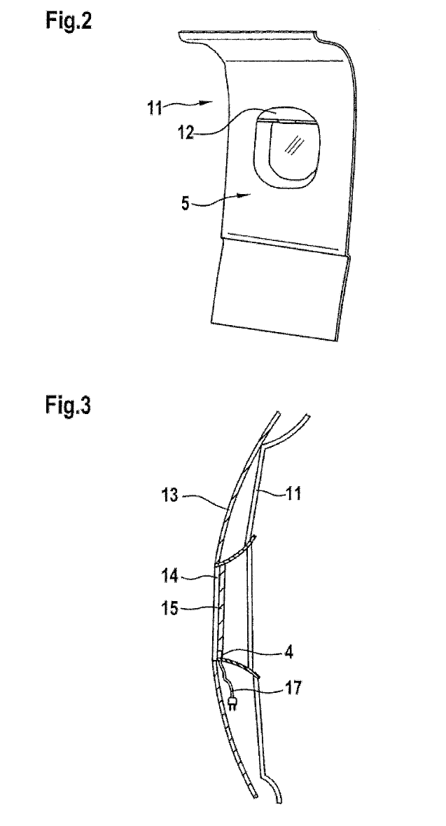

In the control device 6, at least two open or closed control loops are realized in analogue or digital form. The control device 6 emits a signal to a first adjusting device 7 or a second adjusting device 8, depending on the difference between the desired brightness value and the actual brightness value. The first adjusting device 7 acts on a blackout device 9 provided at the windows 5. The blackout device 9 can be configured as an electric blind (reference symbol 12; see FIG. 2) or as an electrochromic coating (reference symbol 15; see FIG. 2). An electrochromic coating changes its transmissivity to light depending on an electrical DC voltage applied. In this way, the first adjusting device 7 can influence the external light entering the cabin 10. The first adjusting device 7 and the second adjusting device 8 can also be integrated in the control device 6.

The second adjusting device 8 is configured to control the brightness of the artificial light emitted by the cabin lighting 3. Preferably, the system or the control device 6 is configured so as to use as much light as possible from the surrounding environment for illuminating the cabin and as little artificial light from the cabin lighting 3 as possible. In this way, it is possible to make an energy saving.

FIG. 2 shows side panelling 11 for panelling the inner side of an aeroplane fuselage. The side panelling 11 has cutouts, into which a window 5 is introduced. The window 5 has a blind 12, which can be opened and closed manually or electromechanically. It is also possible for curtains (not illustrated) which can be drawn to be used on the side in front of the side part 11. Furthermore, the above-described electrochromic coating can additionally be provided on the window 5. In this way, the passenger can screen off the external light entering himself, if required, independently of the system for regulating the brightness.

FIG. 3 shows a schematic illustration of a section through a region of an outer shell 13 of an aeroplane fuselage. On its inwardly pointing side, the outer shell 13 is provided with side panelling 11 illustrated in FIG. 2. The window 5 has a pane 14. The. pane 14 is provided with a coating 15, which preferably changes its transmissivity when an electrical voltage is applied. In addition, the window 5 has a sensor 4, which detects the brightness of external light. The brightness value detected by the sensor 4 is passed on to the control device 6 described in connection with FIG. 1 via a signal transmission means 16, which can be in the form of a simple cable. The sensor 4 can be in the form of a passive sensor 4, which changes its electrical resistance on exposure to light, or in the form of a sensor which produces an electrical voltage when exposed to light. The brightness value can be processed with passive or active electronics.

The brightness level actually prevailing in the cabin can also be determined by a further sensor 40 arranged in the cabin. The system can be configured such that it only blacks out the windows 5 to the extent that the passengers are not affected by glare but a sufficient, preset brightness is still maintained. When there is a brightness level which is too low, the cabin lighting 3 can additionally be switched on. In order to provide particular comfort, individual windows can also have an input device 16 and a control device 6, with the result that the passengers seated next to said windows can automatically regulate the brightness of incoming and artificial light. In a simplified embodiment, the passengers can perform the regulation for driving the blackout unit 9 for their own window 5 by setpoint feedforward. In this case the system regulates the brightness regionally using the light entering through a plurality of windows 5 and possibly by means of the cabin lighting 3, but individual passengers can adjust a brightness which they perceive to be agreeable individually. The reading light switches which are generally provided can likewise be driven by the second adjusting device 8 or switched on and off by the passengers automatically.

The control device 6 can be configured such that the regulation of the brightness via the blackout unit 9 has priority over the regulation of the cabin lighting 3. The control device 6 can also involve damping of the controlled system by means of analogue electronics or with a digital implementation in order that hectic changes in the transmissivity are not made in the event of rapidly changing light conditions in cloud fields. As a result, disruption to the passengers and mutual influencing of the regulation of the cabin lighting and the blackout device 9 are avoided. Preferably, the aeroplane also has an aeroplane management system, which is designed to overwrite the commands of the control device or switch off functions.

### LIST OF REFERENCE SYMBOLS

1 Aeroplane

2 Region

3 Lighting

4 Sensor

5 Window

6 Control device

7 First adjusting device

8 Second adjusting device

9 Blackout unit

10 Cabin

11 Side panelling

12 Blind

13 Outer shell

14 Pane

15 Coating

16 Input device

17 Signal transmission means

1. A system for regulating an adjustable brightness level in a cabin of an aeroplane, having a control device, which is designed to regulate a preset brightness value comprising:
an input unit for inputting a predetermined brightness value,
at least one sensor detecting the brightness, and
an adjusting device for influencing at least one light source on the basis of a brightness value determined by the sensor.

2. The system for regulating an adjustable brightness level according to claim 1, wherein the light source is external light entering from outside through windows, and in that the windows have a blackout unit, and these blackout units are driven by the adjusting device for influencing the light source.

3. The system for regulating an adjustable brightness level according to claim 2, wherein the blackout unit is a layer applied to the window which changes its transmission when an electrical voltage is applied.

4. The system for regulating an adjustable brightness level according to claim 2, wherein the blackout unit is formed from non-transmissive or slightly transmissive materials which can be drawn over the windows electromechanically, so as to at least partially cover said windows.

5. The system for regulating an adjustable brightness level according to claim 1, wherein an adjusting device for influencing the light source acts on lighting provided in the cabin, and in that the control device performs the regulation depending on the predetermined brightness value and the measured brightness value.

6. System The system for regulating an adjustable brightness level, wherein both a first adjusting device for influencing the light source according to claim 2 is provided and a second adjusting device acting on lighting provided in the cabin is provided and therefore both the external light entering the cabin and the lighting in the cabin are regulated by the system.

7. The system for regulating an adjustable brightness level according to claim 6, wherein the first adjusting device and the second adjusting device are decoupled from one another and therefore perform the regulation independently of one another.

8. The system for regulating an adjustable brightness level according to claim 6, wherein the first adjusting device and the second adjusting device are controlled via a common master unit.

9. The system for regulating an adjustable brightness level according to claim 6, wherein the first adjusting device for influencing the blackout unit is designed with priority over the second adjusting device for influencing the lighting.

10. The system for regulating an adjustable brightness level according to claim 1, wherein the regulation has measures for damping the controller in order to damp rapid or fluctuating changes in the brightness value.

11. The system for regulating an adjustable brightness level according to claim 1 wherein a brightness value can be predetermined manually beyond the brightness value detected by the sensor via the input unit.

12. The system for regulating an adjustable brightness level according to claim 1, wherein a sensor detecting the brightness is arranged on the windows and determines the brightness of external light entering.

13. An aeroplane, equipped with at least one system according to claim 1.

14. The aeroplane according to claim 13, further comprising an aeroplane management system which is superordinate to the system and which is designed to overwrite any adjustments of the system or deactivate functions.
